(19) United States
(12) Patent Application Publication
(10) Pub. No.: US 2025/0354828 A1
(43) Pub. Date: Nov. 20, 2025

(54) TOPOLOGY MAP GENERATION APPARATUS AND METHOD

(71) Applicants: HYUNDAI MOTOR COMPANY, Seoul (KR); Kia Corporation, Seoul (KR)

(72) Inventors: Kyungzun RIM, Hwaseong-si (KR); Hotaek HAN, Hwaseong-si (KR)

(21) Appl. No.: 18/913,718

(22) Filed: Oct. 11, 2024

(30) Foreign Application Priority Data
May 14, 2024 (KR) 10-2024-0063210

(51) Int. Cl. G01C 21/00; G06F 40/58; G06T 17/20; G06V 30/14

(52) U.S. Cl. CPC G01C 21/3833; G01C 21/3867; G06F 40/58; G06T 17/20; G06V 30/14

(57) ABSTRACT

A topology map generation apparatus may include an image processor configured to detect a polygon from a guide map image, and generate a vertex and an edge based on the detected polygon, and a character processor configured to recognize a character and a character position from the guide map image by using an optical character recognition (OCR), and map the character and the polygon based on the character position, where the image processor stores location information matched to the character in a vertex closest to the character.

### CROSS-REFERENCE TO RELATED APPLICATION

This application claims priority to and the benefit of Korean Patent Application No. 10-2024-0063210 filed in the Korean Intellectual Property Office on May 14, 2024, the entire contents of which is incorporated herein by reference.

### TECHNICAL FIELD

The present disclosure relates to a topology map generation apparatus and method. More particularly, the present disclosure relates to a topology map generation apparatus and method capable of creating a topology map enabling services of position finding and route finding by using a simple guide map.

### BACKGROUND

Conventional mapping technologies often rely on images or LiDAR to create precise maps. These technologies typically require significant time and financial resources, which limits their ability to provide positioning or route-finding services quickly, especially in rapidly changing environments.

For example, current services require a precise map to estimate the current position within a vehicle interior. This map must be created by collecting data using a LIDAR or a camera, and the service can only be provided after this map is generated. As a result, data collection necessitates visiting the location where the service will be offered, which drives up costs. Due to these costs, offering convenient services at short-term events or conferences becomes challenging.

### SUMMARY

The present disclosure is directed to a topology map generation apparatus and method capable of creating a map enabling services of position estimation and route finding for people without collecting the sensor data at the service site.

The present disclosure is also directed to a topology map generation apparatus and method capable of recognizing a character from a guide map by using an OCR module, automatically creating vertices and edges after extracting a polygon by using the image processing technology, and storing the location information in the created topology map by using the recognition result of the OCR module.

A topology map generation apparatus can include an image processor configured to detect a polygon from a guide map image, and generate a vertex and an edge based on the detected polygon, and a character processor configured to recognize a character and a character position from the guide map image by using an optical character recognition (OCR), and map the character and the polygon based on the character position, where the image processor stores location information matched to the character in a vertex closest to the character.

The image processor can be configured to generate a skeleton image skeletonizing the guide map image based on a first polygon mapped to the character among the polygon detected from the guide map image.

The image processor can be configured to fill the first polygon with a black color and fill a portion excluding the polygon with a white color, in the guide map image, in order to binarize the guide map image into black and white.

The image processor can be configured to detect a second polygon excluding the first polygon among the polygon detected from the guide map image and fill the detected second polygon with the black color.

The image processor can be configured to generate the skeleton image including a passage, which is an object classified as the white color excluding the black color through a skeletonization algorithm.

The image processor can be configured to extract the vertex and the edge from the skeleton image by using a Voronoi diagram.

A topology map generation apparatus can further include an interface provider configured to provide an interface for issuing a generation command or a modification command with respect to the topology map including the vertex and the edge to the user.

The interface can include a first interface for adding, removing or newly generating the vertex and the edge and a second interface for adding the location information to the vertex.

The image processor can be configured to, when the character of the guide map image is Korean when storing the location information, also match an English character obtained by translating the Korean into English with the location information.

The image processor can be configured to generate a dependency tree of the detected polygon.

A topology map generation method can include providing a guide map image uploaded by a user, recognizing a character and a character position from the guide map image by using an OCR, detecting a polygon from the guide map image, mapping the character and the polygon based on the character position, generating a vertex and an edge based on the polygon mapped with the character, and storing location information matched to the character in a vertex closest to the character.

The generating the vertex and the edge can include generating a skeleton image skeletonizing the guide map image based on a first polygon mapped to the character among the polygon detected from the guide map image.

The generating the skeleton image may include binarizing the guide map image into black and white, and the binarizing the guide map image into black and white can include filling the first polygon with a black color and filling a portion excluding the polygon with a white color, in the guide map image.

The binarizing the guide map image into black and white can further include detecting a second polygon excluding the first polygon among the polygon detected from the guide map image, and filling the detected second polygon with the black color.

The generating the skeleton image can further include generating the skeleton image including a passage, which is an object classified as the white color excluding the black color through a skeletonization algorithm.

The generating the vertex and the edge can further include extracting the vertex and the edge from the skeleton image by using a Voronoi diagram.

A topology map generation method can further include providing an interface for issuing a generation command or a modification command with respect to the topology map including the vertex and the edge to the user.

The interface can include a first interface for adding, removing or newly generating the vertex and the edge and a second interface for adding the location information to the vertex.

The storing the location information matched to the character in the vertex closest to the character can include, in the case that the character of the guide map image is Korean when storing the location information, matching an English character obtained by translating the Korean into English with the location information.

The detecting the polygon can include generating a dependency tree of the detected polygon.

In some implementations, a map enabling position finding and route finding for people can be created with only a simple guide map image without directly visiting the site.

In some implementations, since multiple topology maps can be combined by simply matching the names of passages, there is almost no additional cost incurred as the service space is expanded, and users can use it because there is no need to complete the map at once. In addition, since it is convenient not only to expand the map but also modify the map, it is possible to efficiently provide the services of position guidance and route finding to people even in markets or wholesale stores where there are many changes in space.

### BRIEF DESCRIPTION OF THE DRAWINGS

FIG. 1 is a diagram illustrating an example of a topology map system.

FIG. 2 is a block diagram illustrating an example of a topology map generation apparatus.

FIG. 3 is a flowchart illustrating an example of a topology map generation method.

FIG. 4 is a flowchart illustrating an example of a topology map generation method.

FIG. 5 is a flowchart illustrating an example of a skeletonization process among an image processing.

FIG. 6 is a flowchart illustrating an example of a process of generating a Voronoi diagram in an image processing according to an embodiment.

FIG. 7 is a flowchart illustrating an example of a topology map generation method.

FIG. 8 is a diagram for explaining a computing device.

### DETAILED DESCRIPTION

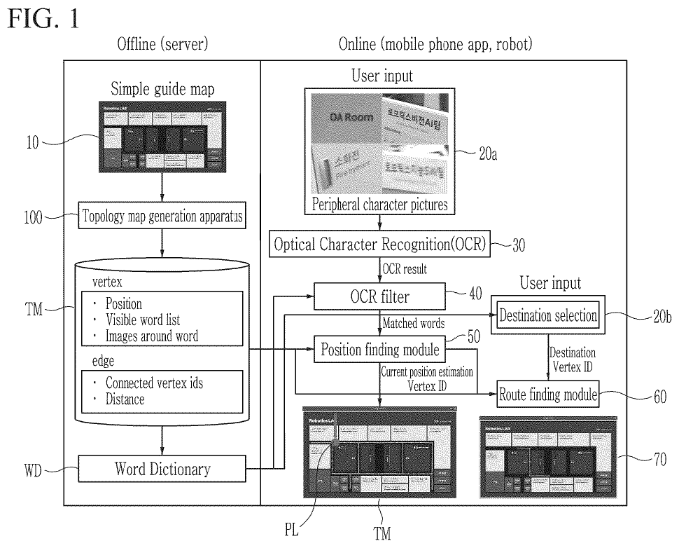

FIG. 1 is a diagram illustrating an example of a topology map system.

When the user provides peripheral character pictures into the user input 20a through an application or the like, the topology map system can recognize a character through an optical character recognition (OCR) 30 and find a matched character through an OCR filter 40, and, based on this, can estimate a current position PL of the user from a topology map TM through a position finding module 50.

Furthermore, when the user inputs a destination selection 20b, the topology map system can provide a topology map-based path 70 through a route finding module 60 based on the estimated current position PL of the user.

In FIG. 1, a topology map generation apparatus 100 can generate a topology map from a simple guide map image 10.

The topology map generation apparatus 100 can create the topology map TM enabling services of position finding and route finding by using the simple guide map.

The topology map generation apparatus 100 can operate offline and on a server. The greatest difference from the existing precise map creation lies in that a map enabling services of position estimation and route finding for people without collecting the sensor data at the service site can be created.

The topology map generation apparatus 100 can be configured as a process of creating a vertex and an edge and a process of inputting location information. The topology map generation apparatus 100 can include an automatic mode and a manual mode in all of the two processes.

For example, in the automatic mode, the topology map generation apparatus 100 can recognize a character from a guide map image 10 by using the OCR 30, extract a polygon by using the image processing technology to automatically create the vertex and the edge, and store the location information in the created topology map TM by using the recognition result of the OCR 30.

By way of further example, in the manual mode, the topology map generation apparatus 100 can provide, to the user, an interface for generating and/or modifying the topology map TM.

The topology map generation apparatus 100 can store the location information in the vertex of the topology map TM. For example, the topology map generation apparatus 100 can store a position information of a location, a character list, a character-peripheral image, or the like, in the vertex of the topology map TM.

The topology map generation apparatus 100 can store a distance between vertices, information of the connected vertices, or the like, in the edge of the topology map TM.

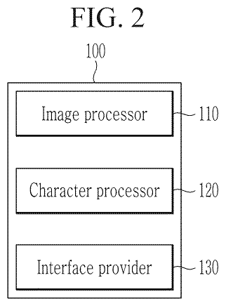

FIG. 2 is a block diagram illustrating an example of the topology map generation apparatus. The description will be made with reference to FIG. 1.

Referring to FIG. 2, the topology map generation apparatus 100 can include an image processor 110, a character processor 120, and an interface provider 130.

The image processor 110 can detect the polygon from the guide map image 10. The image processor 110 can generate a dependency tree of the detected polygon.

The image processor 110 can generate the vertex and the edge based on the detected polygon. The topology map TM can be implemented with the vertices and the edges generated on the guide map image 10. In some implementations, the vertex may represent one point on a map or graph. In some implementations, the edge may represent a connection line connecting adjacent vertices.

The image processor 110 can store the location information matched with the character in the vertex closest to the character.

For example, during the process of creating the vertex and the edge, the image processor 110 can map the character recognized by using the OCR 30 and the polygon corresponding to a character position. The image processor 110 can determine the vertex closest to the character in the topology map TM by using the mapped character and polygon, and store the location information matched with the character in the corresponding vertex.

In some implementations, when the character of the guide map image 10 is Korean when storing the location information, the image processor 110 can also match English characters obtained by translating the corresponding Korean into English with the location information.

For example, since signboards of the shop are typically formed in English, the image processor 110 may match not only the character shown in the guide map image 10 but also characters translated into English with the location information.

For example, when the guide map shows Korean characters “ [symbol] ”, not only the Korean characters “ [symbol] ” but also “ZARA” written on the signboard needs to be recognized as the location information for the shop of ZARA. Therefore, when the location name on the guide map is Korean, the image processor 110 can utilize a translator and store both of the Korean and English terms in the topology map TM as the location information, and when location name is English, it can store only the English term in the topology map. In some implementations, several types of language can be selected.

The image processor 110 can generate a skeleton image skeletonizing the guide map image 10 based on a first polygon mapped with the character among the polygon detected from the guide map image 10.

The image processor 110 can fill the first polygon with black color and fill a portion excluding the polygon with a white color, in the guide map image 10, in order to binarize the guide map image 10 into black and white.

The image processor 110 can detect a second polygon excluding the first polygon from the polygons detected from the guide map image, and fill the detected second polygon with the black color.

The image processor 110 can generate the skeleton image including a passage, which is an object classified as the white color excluding the black color through a skeletonization algorithm.

The image processor 110 can extract the vertex and the edge from the skeleton image by using a Voronoi diagram. For example, the image processor 110 can generate the Voronoi diagram or a Voronoi graph including the vertex and the edge based on the skeleton image.

The character processor 120 can recognize character and the character position from the guide map image by using optical character recognition (OCR).

The character processor 120 can map the character and the polygon based on the character position. For example, the character processor 120 can find the polygons on which the characters are positioned respectively by using character position information within the guide map image 10 recognized through the OCR.

The interface provider 130 can provide an interface for issuing a generation command or a modification command with respect to the topology map including the vertex and the edge to the user.

The interface can include a first interface for adding, removing or newly generating the vertex and the edge and a second interface for adding the location information to the vertex.

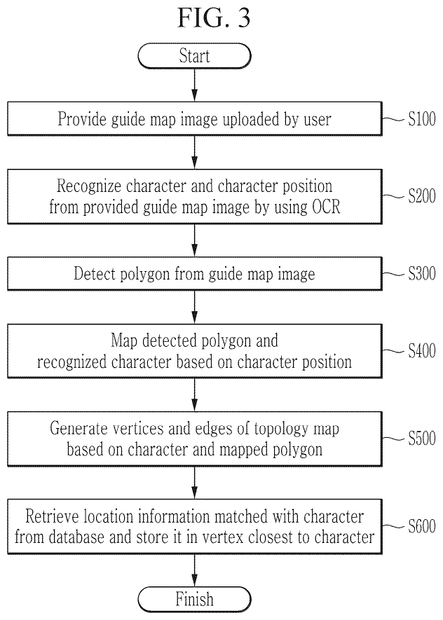

FIG. 3 is a flowchart illustrating an example of a topology map generation method. A topology map generation method of FIG. 3 may be performed through the topology map generation apparatus 100 (see FIG. 2).

In FIG. 3, at step S100, the topology map generation apparatus 100 can provide the guide map image uploaded by the user. When the user uploads a guide map image through a mobile application, the topology map generation apparatus 100 can prepare or provide the corresponding guide map in order to generate the topology map.

At step S200, the topology map generation apparatus 100 can recognize a character and the character position from the provided guide map image by using OCR. At step S300, the topology map generation apparatus 100 can detect the polygon from the guide map image.

At step S400, the topology map generation apparatus 100 can map the character recognized based on the character position and the detected polygon.

At step S500, the topology map generation apparatus 100 can generate the vertex and the edge of the topology map based on the character and the mapped polygon.

At step S600, the topology map generation apparatus 100 can retrieve the location information matched with the character from a database and store them in the vertex closest to the character.

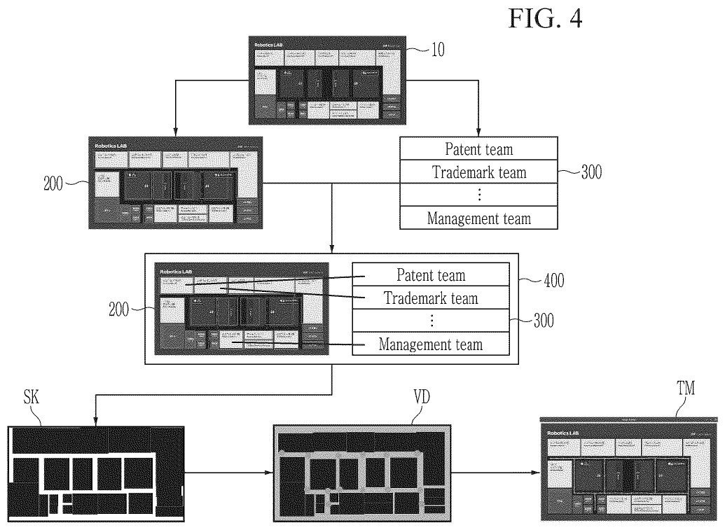

FIG. 4 is a flowchart illustrating an example of a topology map generation method. FIG. 4 may be a flowchart of the topology map generation method according to an implementation of FIG. 3. The description will be made with reference to FIG. 3.

In FIG. 4, the topology map generation apparatus 100 can generate a recognized character list 300 from the guide map image 10 through character recognition.

The topology map generation apparatus 100 can detect a plurality of polygons 200 from the guide map image 10. The plurality of polygons 200 can be detected from the guide map as a quadrangle box. The plurality of polygons 200 can represent a specific region or position in the guide map, respectively.

The topology map generation apparatus 100 can map the recognized character list 300 and the polygons 200. For example, the topology map generation apparatus 100 can find the matched polygons with the character position information included in each character.

The topology map generation apparatus 100 can generate the skeleton image SK with respect to the guide map image 10 through skeletonization based on mapping data 400 of a polygon 200 and the character list 300.

The skeleton image SK can recognize a passage in the guide map along which the user can pass.

The topology map generation apparatus 100 can extract the vertex and the edge from the skeleton image SK and generate the Voronoi diagram VD.

The Voronoi diagram VD can generate a plurality of vertices and the edges in a region recognized as the passage.

The topology map generation apparatus 100 can generate the topology map TM by using the Voronoi diagram VD.

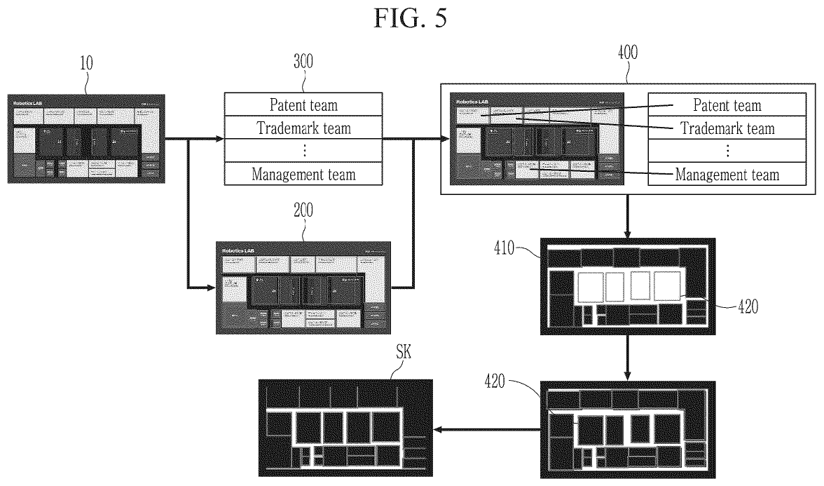

FIG. 5 is a flowchart illustrating an example of a skeletonization process among an image processing. FIG. 5 is a drawing for explaining the step of generating the skeleton image SK in FIG. 4.

The step of generating the skeleton image SK can be performed through the skeletonization algorithm (skeletonization). The skeletonization algorithm can detect the structure of the image through the process of binarizing the image into black and white and finding the contour.

In FIG. 5, when the guide map image 10 is received from the user, the topology map generation apparatus 100 can generate the character list 300 by detecting the character and the character position through the OCR, and can detect the polygon 200 through image processing.

The topology map generation apparatus 100 can map the polygon 200 and the detected character of the character list 300. For example, the topology map generation apparatus 100 can find and match whether a character exists in an interior of the polygon based on the character position.

Based on the mapping data 400 of the polygon 200 and the character list 300, with respect to the first polygons 410 matched with the character among the plurality of polygons 200, the topology map generation apparatus 100 can fill the interior with the black color.

The topology map generation apparatus 100 can detect the second polygons 420 excluding the first polygons 410. When the second polygons 420 is detected, the topology map generation apparatus 100 can also fill the second polygons 420 with the black color. The process of detecting the second polygons 420 and filling them with the black color can be manually performed by the user.

The topology map generation apparatus 100 can extract the passage, which is defined as a white color portion remaining after filling all the polygons with the black color through a skeletonization image processing algorithm.

The topology map generation apparatus 100 can generate the skeleton image SK in black and white including the extracted passage.

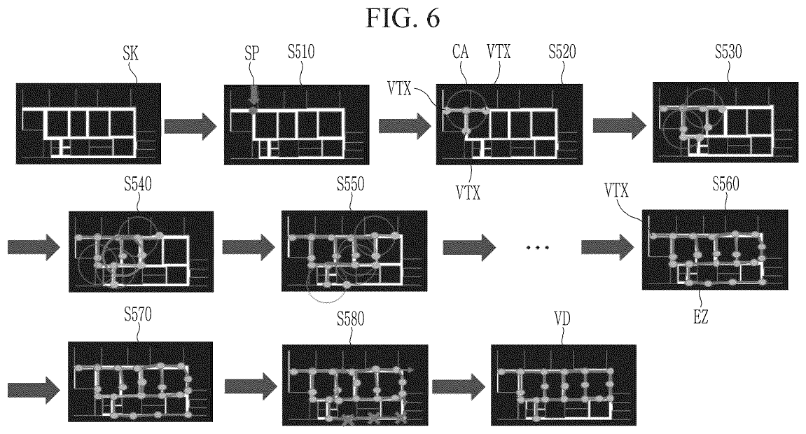

FIG. 6 is a flowchart illustrating an example of a process of generating the Voronoi diagram in an image processing. FIG. 6 is a drawing for explaining the step of generating the Voronoi diagram VD in FIG. 4.

In FIG. 6, at step S510, when the skeleton image SK is provided, the topology map generation apparatus 100 can set a starting point SP according to the user input. The starting point SP can be set in the white color portion defined as the passage.

At step S520, the topology map generation apparatus 100 can set a specific region CA based on the starting point SP, and can detect a point different by more than a specific angle and farthest from the starting point SP, among points of the white color portion within the specific region CA, as a vertex VTX.

At step S530, the topology map generation apparatus 100 can add new vertices by repeating the process of the step S520 based on the vertex VTX detected at the step S520.

At step S540 to a step S560, the topology map generation apparatus 100 can repeat the process of the step S530 according to the white color portion in the skeleton image SK.

At step S570, the topology map generation apparatus 100 can supplement the vertex and the edge by detecting an available path, in addition to the vertex VTX and the edge EZ automatically generated through the step S520 to the step S560.

At step S580, the topology map generation apparatus 100 can obtain the Voronoi diagram VD by performing position change, addition, removal, or the like of the vertex and the edge according to the user input with respect to the generated vertex and edge.

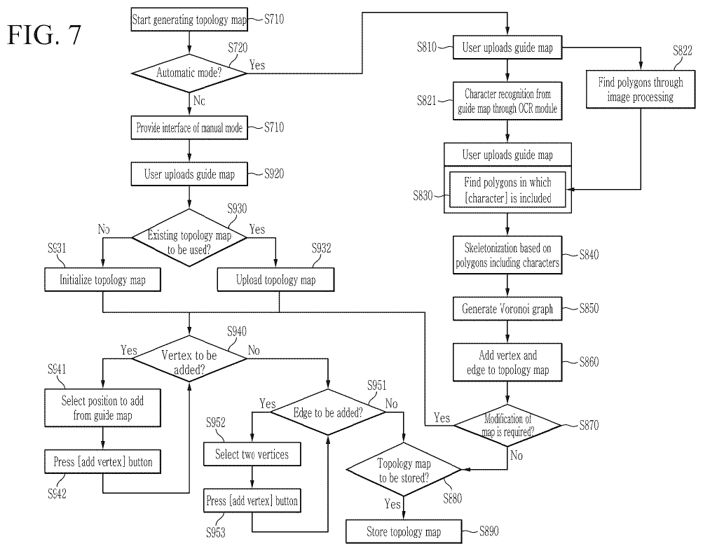

FIG. 7 is a flowchart illustrating an example of a topology map generation method. A topology map generation method of FIG. 7 can be performed through the topology map generation apparatus 100 (see FIG. 1).

In FIG. 7, after starting to generate the topology map at step S710, at step S720, the topology map generation apparatus 100 can check whether it is in the automatic mode.

In the case of the automatic mode, when the guide map is uploaded by the user at step S810, the topology map generation apparatus 100 can recognize the character from the guide map through the OCR module at step S821, and can find the polygons through image processing at step S822.

At step S830, the topology map generation apparatus 100 can detect the first polygon to which the character is mapped among the polygons.

At step S840, the topology map generation apparatus 100 can generate the skeleton image from the guide map through skeletonization based on the first polygon in which the character is included.

At step S850, the topology map generation apparatus 100 can generate the Voronoi graph or the Voronoi diagram from the skeleton image.

At step S860, the topology map generation apparatus 100 can add the vertex and the edge required for the generated Voronoi graph.

At step S870, when the topology map including the vertex and the edge is generated, the topology map generation apparatus 100 can determine whether modification of the map is required.

When the modification of the map is not required, the topology map generation apparatus 100 can store the generated topology map at step S890, depending on determining whether to store the topology map at step S880.

When the modification of the map is required, the topology map generation apparatus 100 can provide, to the user, an interface to manually modify topology map through step S940 to step S953.

The interface can include the first interface for adding, removing or newly generating the vertex and the edge and the second interface for adding the location information to the vertex.

At step S910, when the manual mode rather than the automatic mode is selected after starting generation of the topology map, the topology map generation apparatus 100 can provide, to the user, an interface of the manual mode.

When the user uploads the guide map at step S920, the topology map generation apparatus 100 can allow the user to select whether to use the existing topology map through the interface, at step S930.

At step S931, when the user selects not to use the existing topology map, the topology map generation apparatus 100 can initialize the topology map.

At step S932, when the user selects to use the existing topology map, the topology map generation apparatus 100 can upload the existing topology map.

At the step S940, the topology map generation apparatus 100 can allow the user to select whether to use the vertex through the interface.

When the user selects to add the vertex, the topology map generation apparatus 100 can provide an interface to add the vertex to the user.

At step S941, according to the topology map generation apparatus 100, the user selects the position in the guide map to add the vertex. At step S942, when the vertex adding button (e.g., add vertex) is input, the vertex can be added to the corresponding position.

At step S951, when the addition of the vertex is completed, the topology map generation apparatus 100 can allow the user to select whether to add the edge.

At the step S953, when the user selects the addition of the edge, the topology map generation apparatus 100 can provide an interface, and when the user selects two adjacent vertices at step S952 and inputs the edge adding button (e.g., add the edge), it can add the edge to the corresponding position.

At step S890, when the addition of the vertex and the edge is completed and the topology map is generated, the topology map generation apparatus 100 can store the topology map according to the user input.

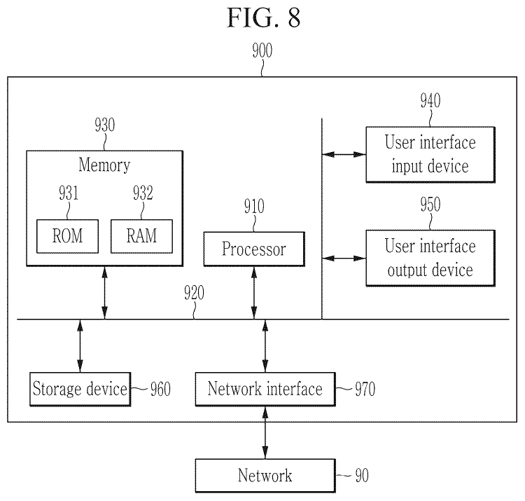

FIG. 8 is diagram for explaining an example of a computing device.

Referring to FIG. 8, a topology map generation apparatus and method can be implemented by using a computing device 900.

The computing device 900 can include at least one of a processor 910, a memory 930, the user interface input device 940, the user interface output device 950 or a storage device 960 that communicate through a bus 920. The computing device 900 can also include a network interface 970 electrically connected to a network 90. The network interface 970 can transmit or receive signals with other entities through the network 90.

The processor 910 can be implemented in various types such as a micro controller unit (MCU), an application processor (AP), a central processing unit (CPU), a graphic processing unit (GPU), a neural processing unit (NPU), and the like, and can be any type of semiconductor device capable of executing instructions stored in the memory 930 or the storage device 960. The processor 910 can be configured to implement the functions and methods described above with respect to FIG. 1 to FIG. 7.

The memory 930 and the storage device 960 can include various types of volatile or non-volatile storage media. For example, the memory can include read-only memory (ROM) 931 and a random-access memory (RAM) 932. In some implementations, the memory 930 can be located inside or outside processor 910, and the memory 930 can be connected to the processor 910 through various known means.

In some implementations, at least some configurations or functions of the topology map generation apparatus and method can be implemented as a program or software executable by the computing device 900, and program or software can be stored in a computer-readable medium.

In some implementations, at least some configurations or functions of the topology map generation apparatus and method can be implemented by using hardware or circuitry of the computing device 900, or can also be implemented as separate hardware or circuitry that may be electrically connected to the computing device 900.

What is claimed is:

1. A topology map generation apparatus, comprising:
an image processor configured to:
detect a polygon from a guide map image, and
generate a vertex and an edge based on the detected polygon; and
a character processor configured to:
identify a character and a character position from the guide map image by using an optical character recognition (OCR), and
associate the character with the polygon based on the character position,
wherein the image processor is configured to store location information matched to the character in a vertex closest to the character.

2. The topology map generation apparatus of claim 1, wherein the image processor is configured to generate a skeleton image skeletonizing the guide map image based on a first polygon mapped to the character among the polygon detected from the guide map image.

3. The topology map generation apparatus of claim 2, wherein the image processor is configured to, in the guide map image, fill the first polygon with a black color and fill a portion excluding the polygon with a white color, to thereby binarize the guide map image into black and white.

4. The topology map generation apparatus of claim 3, wherein the image processor is configured to:
detect a second polygon excluding the first polygon among the polygon detected from the guide map image, and
fill the detected second polygon with the black color.

5. The topology map generation apparatus of claim 4, wherein the image processor is configured to:
generate the skeleton image comprising a passage, which is an object classified as the white color excluding the black color through a skeletonization algorithm.

6. The topology map generation apparatus of claim 2, wherein the image processor is configured to extract the vertex and the edge from the skeleton image by using a Voronoi diagram.

7. The topology map generation apparatus of claim 1, further comprising an interface provider configured to provide, to a user, an interface for issuing a generation command or a modification command with respect to the topology map comprising the vertex and the edge.

8. The topology map generation apparatus of claim 7, wherein the interface comprises (i) a first interface configured to add, remove or generate a vertex and an edge and (ii) a second interface configured to add the location information to the vertex.

9. The topology map generation apparatus of claim 1, wherein the image processor is configured to, based on the character of the guide map image being Korean texts when storing the location information, match an English character obtained by translating the Korean texts into English with the location information.

10. The topology map generation apparatus of claim 1, wherein the image processor is configured to generate a dependency tree of the detected polygon.

11. A topology map generation method, comprising:
receiving a guide map image uploaded by a user;
identifying a character and a character position from the guide map image by using an OCR;
detecting a polygon from the guide map image;
associating the character with the polygon based on the character position;
generating a vertex and an edge based on the polygon associated with the character; and
storing location information matched to the character in a vertex closest to the character.

12. The topology map generation method of claim 11, wherein generating the vertex and the edge comprises generating a skeleton image skeletonizing the guide map image based on a first polygon mapped to the character among the polygon detected from the guide map image.

13. The topology map generation method of claim 12, wherein:
generating the skeleton image comprises binarizing the guide map image into black and white, and
binarizing the guide map image into black and white comprises, in the guide map image, filling the first polygon with a black color and filling a portion excluding the polygon with a white color.

14. The topology map generation method of claim 13, wherein binarizing the guide map image into black and white further comprises:
detecting a second polygon excluding the first polygon among the polygon detected from the guide map image, and
filling the detected second polygon with the black color.

15. The topology map generation method of claim 14, wherein generating the skeleton image further comprises generating the skeleton image comprising a passage, which is an object classified as the white color excluding the black color through a skeletonization algorithm.

16. The topology map generation method of claim 12, wherein generating the vertex and the edge further comprises extracting the vertex and the edge from the skeleton image by using a Voronoi diagram.

17. The topology map generation method of claim 11, further comprising providing an interface for issuing a generation command or a modification command with respect to the topology map comprising the vertex and the edge to the user.

18. The topology map generation method of claim 17, wherein the interface comprises (i) a first interface configured to add, remove, or generate a vertex and an edge and (ii) a second interface configured to add the location information to the vertex.

19. The topology map generation method of claim 11, wherein storing the location information matched to the character in the vertex closest to the character comprises, based on the character of the guide map image being Korean texts when storing the location information, matching an English character obtained by translating the Korean texts into English with the location information.

20. The topology map generation method of claim 11, wherein detecting the polygon comprises generating a dependency tree of the detected polygon.
